(19) United States
(12) Patent Application Publication
(10) Pub. No.: US 2024/0138036 A1
(43) Pub. Date: Apr. 25, 2024

(54) INDUCTION GRILL

(71) Applicant: W.C. BRADLEY CO., Columbus, GA (US)

(72) Inventors: JAMES D. KRING, Opelika, AL (US); RAMIN KHOSRAVI RAHMANI, Columbus, GA (US); SLEIMAN ABDALLAH, Columbus, GA (US); Thomas Kessler, Columbus, GA (US); Jonathan Whitten, Fortson, GA (US)

(21) Appl. No.: 18/376,924

(22) Filed: Oct. 4, 2023

Related U.S. Application Data
(60) Provisional application No. 63/413,302, filed on Oct. 5, 2022.

(51) Int. Cl. H05B 6/12; A47J 37/07; H05B 6/36

(52) U.S. Cl. CPC H05B 6/1236; A47J 37/0709; A47J 37/0786; H05B 6/365; A47J 2202/00; H05B 2213/05; H05B 2213/07

(57) ABSTRACT

An outdoor cooking grill has a cooking surface and at least one induction coil below the cooking surface. A power supply provides current to the at least one induction coil heating the cooking surface.

### CROSS-REFERENCE TO RELATED CASES

This application claims the benefit of U.S. provisional patent application Ser. No. 63/413,302, filed on Oct. 5, 2022, and incorporates such provisional application by reference into this disclosure as if fully set out at this point.

### FIELD OF THE INVENTION

This disclosure relates to induction cooking in general and, more particularly, to a induction cooking grill.

### BACKGROUND OF THE INVENTION

Electric grills based on resistive heating elements are known to the art. These provide an alternative to combustion-based grilling but may lack the ability to cook as quickly, or at temperatures as high, as may be desired. Electric grills heat a cooking grate and/or food items based on radiative heat transfer. There is little or no additional heat transfer via convection. This combined with the inefficiency resulting from heat being radiated in all directions from the heating elements, and the limited power frequently available from an outlet or a typical battery, may result in sub-par performance.

What is needed is a system and method for addressing the above and related issues.

### SUMMARY OF THE INVENTION

The invention of the present disclosure, in one aspect thereof, comprises an outdoor cooking grill having a cooking surface; at least one induction coil below the cooking surface, and a power supply providing current to the at least one induction coil heating the cooking surface.

In some embodiments the at least one induction coil comprises a plurality of induction coils arranged below the cooking surface. The plurality of induction coils may correspond to a plurality of separately controllable cooking zones on the cooking surface. The grill may include a capacitive food sensor detecting a location of food on the cooking grate.

In some embodiments, the power supply comprises a direct current power source. The power supply may also comprise an alternating current power source.

Some embodiments comprise a shielding layer interposing the cooking surface and the at least one induction coil. A fan may deliver air from at least one of the cooking surface, the at least one induction coil, and the shielding layer to an interior of a cooking chamber containing the cooking surface.

The grill may further comprise a microcontroller controlling operation of the at least one induction coil.

At least a portion of the cooking surface may be removable for placement of an induction compatible cooking implement.

A controller may determine a cooking surface temperature by pulse induction using the at least one induction coil. In some embodiments, a controller determining a food location on the cooking surface by pulse induction using the at least one induction coil. In some cases, such controller activates one of a plurality of induction coils to heat the cooking surface at the food location.

The invention of the present disclosure in another aspect thereof, comprises an outdoor cooking grill with an electrically powered induction coil, a cooking surface in the interior of an outdoor cooking chamber, and a ferrous material proximate the cooking surface that generates heat in response to induced magnetic fields from the induction coil.

In some embodiments, the ferrous material is contained in the cooking surface. The infrared emitter may comprise the ferrous material.

Some embodiments, further comprise an air plenum containing a fan moving air into the outdoor cooking chamber from the electrically powered induction coil.

The invention of the present disclosure, in another aspect thereof, comprises an outdoor cooking grill with a cooking chamber, a ferrous cooking grate at the bottom of the cooking chamber, a firebox containing a plurality of induction coils, and a controller operative to energize the plurality of induction coils in response to user activation, the induction coils causing a heating of the ferrous cooking grate.

Some embodiments further comprise a shielding layer interposing the ferrous cooking grate and the plurality of induction coils. A capacitive sensor may be used by the controller to determine a location of a food item on the cooking grate with the controller activating a subset of the plurality of induction coils to heat the ferrous cooking grate below the food item.

### BRIEF DESCRIPTION OF THE DRAWINGS

FIG. 1 is a simplified front cutaway view of a cooking device with resistive heating elements.

FIG. 2 is a simplified front cutaway view of an induction electric grill according to the present disclosure.

FIG. 3 is a simplified front cutaway view of another induction electric grill according to the present disclosure having a fan.

FIG. 4 is a simplified front cutaway view of another induction electric grill according to the present disclosure having inductive or capacitive grate temperature sensing.

FIG. 5 is a simplified front cutaway view of another induction electric grill according to the present disclosure having inductive or capacitive food location sensing.

FIG. 6 is a flow chart of a control method for dynamic zonal of an induction grill based on grate temperature according to the present disclosure.

FIG. 7 is a flow chart of a control method for sensing grate temperature according to the present disclosure.

FIG. 8 is a flow chart of a control method for sensing grate temperature and food location according to aspects of the present disclosure.

FIG. 9 is a flow chart of a control method for dynamic zonal control based on food location sensing and grate temperature sensing at the location of food according to aspects of the present disclosure.

FIG. 10 is a simplified front cutaway view of another induction electric grill according to the present disclosure having an infrared emitter plate.

FIG. 11 is a perspective view of an induction electric grill according to the present disclosure.

### DETAILED DESCRIPTION OF THE PREFERRED EMBODIMENTS

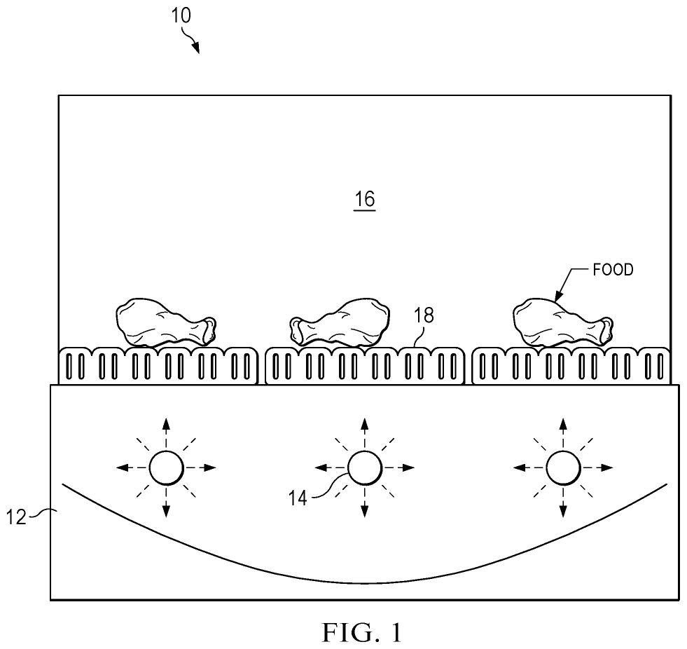

Referring now to FIG. 1, a simplified front cutaway view of a cooking device 10 with resistive heating elements leading to energy loss is shown. An electric grill 10 may use the available AC grid power provided to a house to energize one or more resistive heating elements 14, which may be contained in a firebox 12. An example of a commercially available resistive heating element is sold under the brand name a Calrod®. As voltage is applied to electrical resistors inside the heating elements 14, electrical energy is converted into heat or thermal energy. Temperatures at the outer surfaces of the elements 14 increase and they radiate heat. Radiative heat generated by the heating element 14 provides heat to a cooking surface 18 inside of a cooking chamber 16.

Heat is radiated in all directions from resistive heating elements 14. Therefore not only is the cooking surface 18 heated, but structures below and beside heating element 14 are heated also. A reflector 15 may be used to return some of the heat back toward the cooking surface 18, but the efficiency of this operation varies, and some heat is still wasted as the reflector 15 heats up. Moreover, reflectors are less effective as they become dirty from use in the environment of a cooking appliance.

The cooking surface 18, which may be an open cooking grate, which may share at least some principles of operation with cooking grates used in convective cooking grills. Such grills generating heat from combustion of a fuel (such as gas or charcoal grills) benefit from multiple heat transfer mechanisms including both radiative and convective transfers. Electric grills lack energy transfer into the cooking chamber via convective mass transfer (e.g., combustion products generated in a gas or charcoal grill). This results in a longer initial warmup time for the electric grill, a longer recovery time, and lower temperature and heat available for cooking inside the cooking chamber.

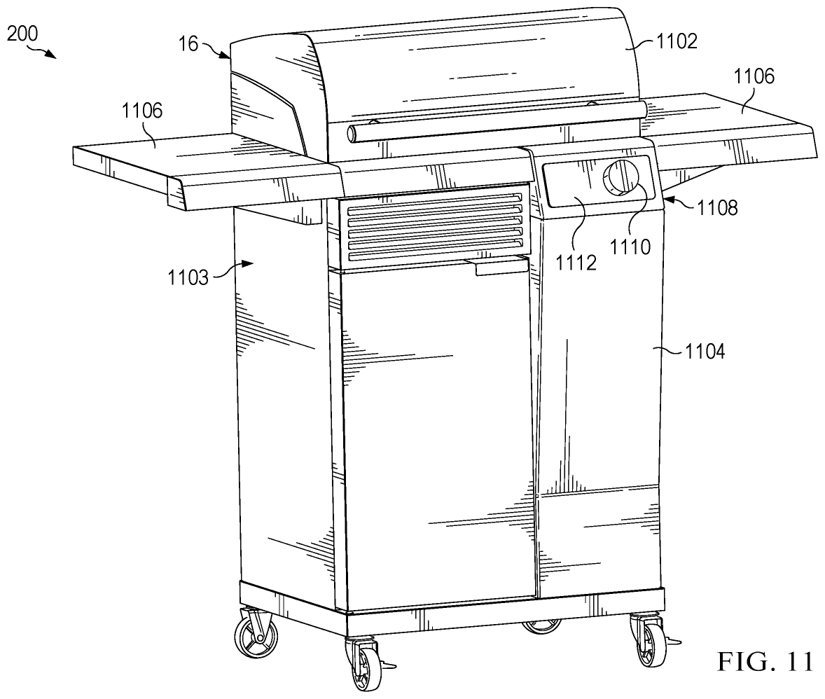

Referring now to FIG. 11 a perspective view of an induction electric grill 200 according to the present disclosure is shown. The grill 200 may comprise a cooking chamber 16 having a separately openable cover 1102. A firebox 1103 may be situated immediately below the cooking chamber 1102 and contain the heat generating mechanisms as described below. The firebox 1103 may be a part of, or may be placed atop of, a cart 1104. In other embodiments, a stand or a permanent installation fixture may be used instead of a cart. In some cases, side shelves 1106 or other accessories are provided.

A control panel 1108 on or near a front of the firebox 1103 and/or cart 1104 may provide a user input mechanisms in the form of control knob 1110, buttons, or other switchgear or devices. This enables the user to select operation and programming for the grill 200. Outputs such as temperature, time, or other information may be displayed on a display 1112 that is part of the control panel 1108. Indicator lights and other output mechanisms may be utilized as well.

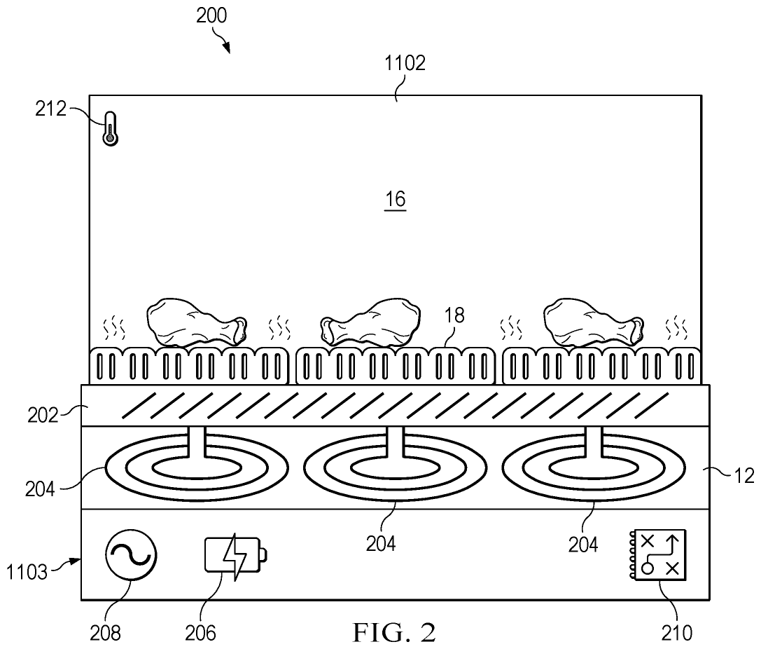

Referring now to FIG. 2, a simplified front cutaway view of one embodiment the induction based electric grill 200 according to the present disclosure is shown. The electric grill system 200 may include one or more induction coils 204 below the cooking grate 18. Three coils 204 are illustrated but it should be understood that more or fewer may be present in some embodiments. The induction coils 204 operate as electromagnets that induce electric currents within the cooking grate 18 itself. The grate 18 has electrically conductive and magnetic material and structural characteristics that produce strong eddy currents when exposed to the alternating electromagnetic field produced by the induction coils 204. In some embodiments, the grate 18 comprises a ferrous material or a ferrous layer subject to heating via induction. Thus, the induction coils 204 generate alternating magnetic fields within the cooking grate 18, which result in alternating electrical currents or eddy currents arising in the cooking grate. This results in heat being generated directly within the cooking grate 18 (e.g., so-called ohmic heat). Where another type of grate, an emitter plate, or a cooking vessel are used, this process of heat generated as a result of induced currents occurs therein.

Some embodiments provide a shielding layer 202 for the coils 204 below the grate 18. The shielding layer 202 may protect the coils 204 from grease or other cooking byproducts.

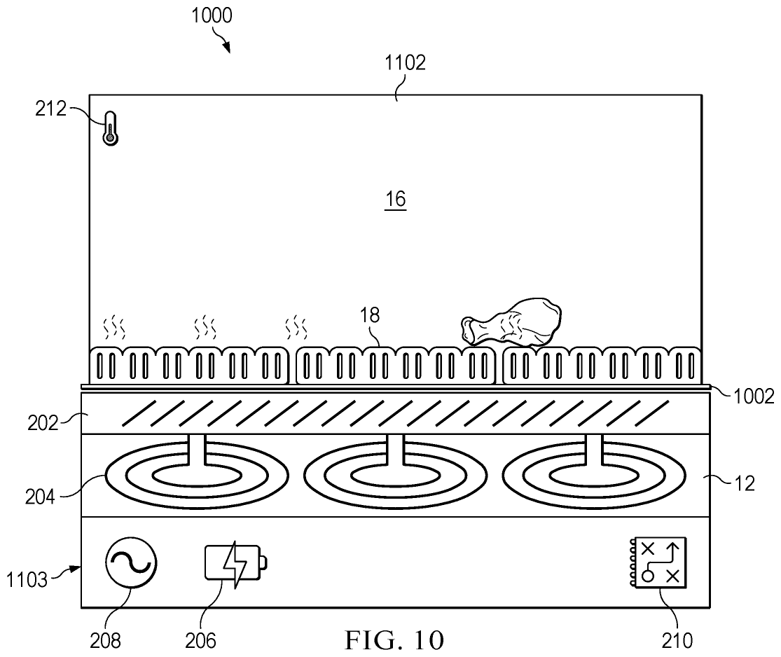

Instead of, or in addition to the grate 18, a griddle and/or infrared emitter plate or some combination thereof may be utilized. FIG. 10 provides a simplified cutaway of an embodiment utilizing an emitter plate 1002 below the cooking grate 18. Where an emitter plate 1002 is used, such plate may be heated via the induction coils instead of or in addition to the grate 18. The emitter plate may comprise a ferrous material or layer subject to heating via induction. Such emitter plate then re-emits heat generated internally in the infrared range for cooking on a suitable surface such as grate 18. While this may result in a loss of efficiency, use of an emitter plate may provide offsetting benefits in terms of the cooking experience versus a purely electrical radiative heating element (e.g., heating elements 14) below a cooking grate. In some embodiments, an emitter plate 1002 may take the place of the shielding layer 202 and have appropriate grease handling or drainage channels to protect the coils 204.

The induction coils 204 may be configured to allow free induction, such that replacing the grilling surface 18 with a different induction ready cooking tool (such as an induction ready pot, skillet, or skewer) is operable.

Planar or non-planar winding of the induction coils 204 may allow the optimization of the alternating electromagnetic field to best induce the electrical currents in the open grate 18 (or a closed grate/griddle or infrared emitter plate, or some combination of the thereof). The coils 204 and grate 18 design may allow for distinct cooking zones or sub-zones (such as concentrically smaller zones) to allow the optimization of the spatial delivery of the available electrical power.

The shielding 202 of the induction coils 204 protects the coils 204 from grease or other food residue produced during the cooking process, and from the heat produced by the cooking grate 18 (whether open grate or closed, or replaced by an infrared emitter plate, or some combination thereof). The shielding 202 allows appropriate directional control of the flow of grease in a safe fashion to an appropriate area (such as a drain cup).

As noted, the free induction design of the induction coils 204 allows the removal of the open grate 18 or closed grate/griddle or infrared emitter plate (or some combination of the above) to be replaced with an induction ready cooking tool such as a pot or pan. However, it also allows the use of non-traditional induction cooking device such as a ferrous metal skewer to cook the skewered food from the inside out when placed over the induction coils.

Temperature sensing of the interior of the cooking chamber 16 may be conducted via temperature probe 212, which can be any temperature probe as known to the art.

Various embodiments of the induction-based grills of the present disclosure allow for an electrically powered grill or appliance to have an enhanced cooking capability. Advances include, but are not limited to, allowing the system 200 to fully deploy the available electrical power, and by reducing warmup and recovery times. Power may be provided by an alternating current (AC) source 208 or a direct current (DC) source 206. The AC source 208 may be household outlet power, or a battery system using an inverter. DC source 206 may comprise a chemical battery.

Various embodiments provide for inductive or capacitive sensing of the location of food on the cooking grate 18 and/or the temperature of the grate 18, allowing optimized deployment of available electrical power. Inductive and capacitive sensing mechanisms may be deployed by any mechanism or method known to the art. Computation and logic necessary to perform these and other methods of the present disclosure may be carried out on a controller 210. The controller 210 may comprise a programmable logic device such as a microprocessor or microcontroller. The controller 210 may comprise one or more integrated circuits with necessary A/D, D/A, and supporting analog circuitry as known to the art. The controller 210 may be powered by the AC source 208 and/or the DC source 206. User controls for inputting desired cooking operations (e.g., knobs and switch gear) may be provided. Similarly, displays and output devices for showing temperature, cooking mode, and other parameters may be provided as is known to the art.

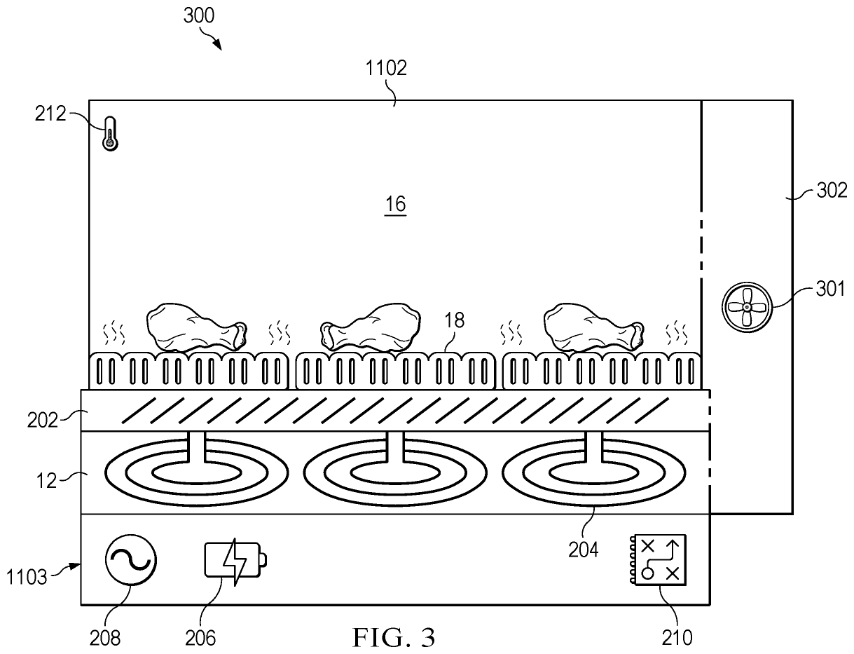

Referring now to FIG. 3, a simplified front cutaway view of another induction electric grill 300 according to the present disclosure is shown. The electric grill system 300 may include a fan 301. The fan 301 may operate selectively within a plenum 302 to provide additional control over temperature and cooking operations as described further below. The fan 301 may be positioned and oriented to enhance the convection of the system to produce quicker heat up and recovery times by harvesting the heat lost from the induction coils 204, the shielding layer 202, or grill/emitter 18. The fan 301 also provides cooling of these components. The fan 301, when in current configuration or in operation with an additional heating element, also provides the ability for indirect cooking.

In all embodiments, appropriate control circuitry may be provided to control the induction coils 204 and fan 301 (if present) while handling user inputs, inductive or capacitive location sensing of food, temperature sensing of the grate and other locations, and all other functions. In some embodiments, the control circuitry may include a controller 210 or another silicon-based processor. For simplicity, wiring, relays, switches, and the like, as are known to the art, are not shown.

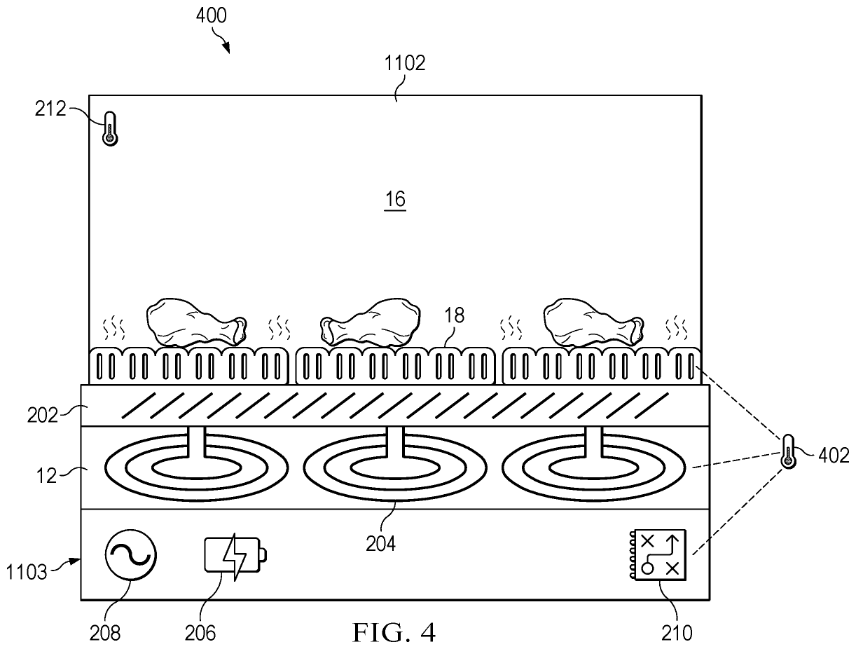

As shown in FIG. 4, some embodiments of an electric grill system 400 provide additional temperature sensors 402. These may be used to monitor temperatures at numerous locations such as, without limitation, at the cooking grate 18, the shielding layer 202, or elsewhere. Such temperature sensors 402 may be based on any suitable technology known to the art. Temperature sensors 402 may provide information to and be operated by the controller 210.

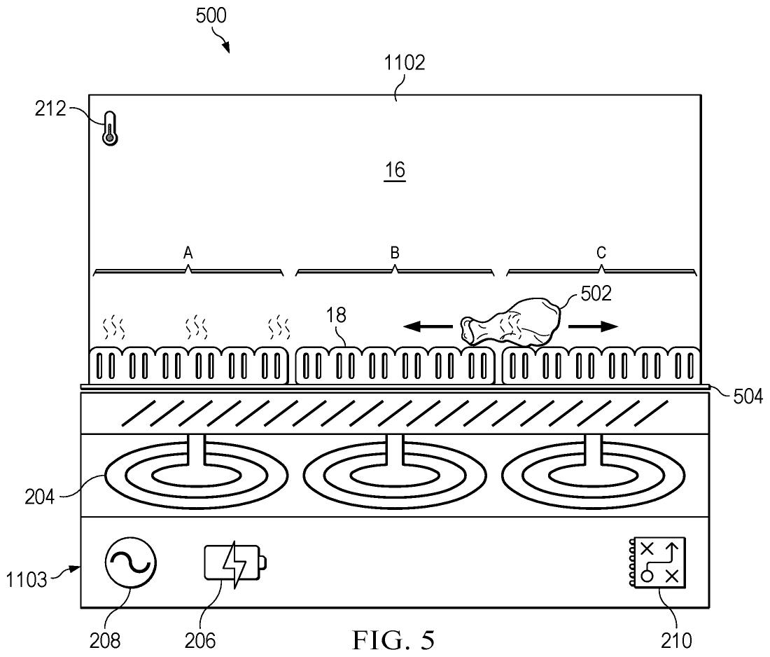

As shown in FIG. 5, some embodiments of an electric grill system 500 provide a food sensing mechanism or sensor array 504 that can be used to detect the presence or location of food items 502 on the cooking grate 18 or other cooking surface. Such food sensing sensor array 504 may comprise capacitive and/or inductive sensing mechanisms or sensors. The sensor array 504 may act as a localizer to provide precise information relating to where and how much food is on the cooking grate 18. The food sensor array 504 may be operated by, and provide its information to, the controller 210.

Particularly in cases where temperatures and/or food can be sensed and known to correspond to a particular region of or on the cooking grate 18, the grate 18 may be divided into specific zones. For example, Zones A, B, and C are shown for the cooking grate 18 in FIG. 5. Each Zone A, B, and C corresponds to a separate induction coil 204. These may be activated separately to control or maintain temperature at a specific zone. In some embodiments induction coils may be divided into groups for activation (i.e., they are not necessarily each activated or controlled individually).

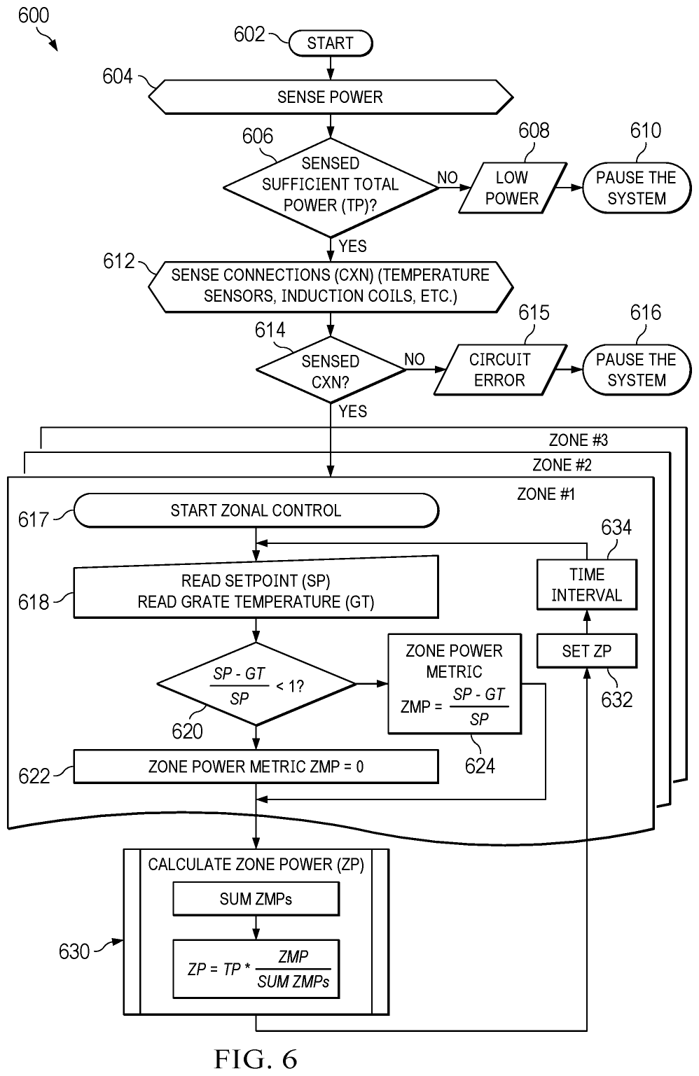

Various control methods may be implemented based on the hardware of the present disclosure. One simplified example of a control method is shown in the flow chart of FIG. 6. Logical control, measurements, calculations, etc. may be executed by the controller 210 or another suitable device. The method 600 starts at step 602, with power being sensed at step 604. If total power available to the device is not sufficient, as determined at step 606, low power may be indicated at step 608 and the system paused at step 610. On the other hand, if sufficient power is determined to be available at step 606, connection to appropriate sensors, coils, and other hardware may be tested at step 612.

As shown at logical step 614, without appropriate connections, a circuit error may be indicated at step 615 (e.g., via an appropriate display panel or indicator light) and the system paused at step 616. If connections are present as needed at step 614, control and operation for the plurality of zones may begin. Three separate control zones are shown in FIG. 6, but it should be understood that more or fewer zones may be present depending upon the particular configuration of the cooking system, cooking surface, and/or inductive heating system. Additionally, each zone does not necessarily have the exact same control methodology

As shown at step 617 zonal control may begin and a setpoint is read, along with a grate temperature, at step 618. At step 620 it may be determined whether the quantity of the set point minus the grate temperate, divided by the setpoint, is less than 1. If so, a zone power metric for the zone in question is set to zero at step 622. If the quantity of the set point minus the grate temperate, divided by the setpoint, is not less than 1, the instant zone power metric is set to the quantity of the setpoint minus the grate temperature, divided by the setpoint.

With steps 617 through 624 occurring for all zones, zone power is calculated at step 630. This includes summing the zone metric power results and then setting the zone power to the total power available multiplied by the ratio of the zone power divided by their sums, for use in setting the zone power at step 632 (for each zone). As the power may be adjusted continually, or on a periodic basis, a time interval may pass as shown at step 634, whereupon steps 618 through 624 are repeated for each zone, along with step 630, and then steps 632 through 634 again for each zone. Of course, this control method may be interrupted by powering down or another user selected operation.

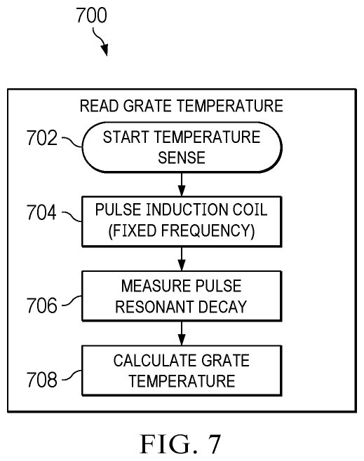

FIG. 7 is a flow chart of a control method for sensing grate temperature according to the present disclosure. Grate temperatures may be sensed at any plurality of locations within a cooking device of the present discourse. A grate, griddle, or other cooking surface or an emitter plate may also be an object for which temperatures are sensed according to the present disclosure. In the example shown, at step 702 the temperature sensing process begins. A fixed frequency pulse induction coil is energized at step 704 and the pulse resonant decay is sensed at step 706. These may occur using suitable hardware as is known in the art and provided to the controller 210 or/or other control logic. At step 708 the temperature may be calculated based on relationships between the temperature and pulse resonant decay.

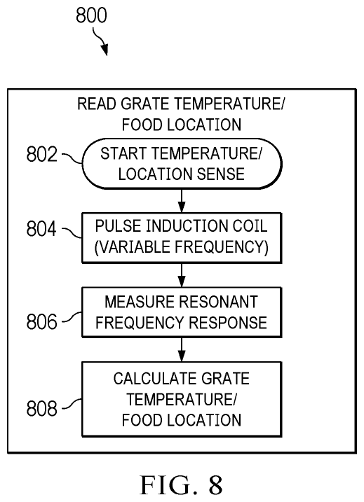

FIG. 8 is a flow chart of a control method for sensing grate temperature and food location according to aspects of the present disclosure. Grate temperatures and food locations may be sensed at any plurality of locations within a cooking device of the present disclosure. A grate, griddle, or other cooking surface, or an emitter plate may also be an object for which temperatures are sensed according to the present disclosure. In the example shown, at step 802 the temperature sensing process begins. At step 804 a variable frequency pulse induction coil is energized and the resonant frequency response is measured at step 806. At step 808 the grate temperature and food location may be calculated based on known relationships between these values and the measured resonant frequency response. Steps 804, 806, and 808 may occur using suitable hardware as is known in the art as controlled by the controller 210 and/or other logical circuitry. In some embodiments, these pulsing and sensing operations occur at a plurality of locations on a cooking surface thereby giving indication of food location and temperature at locations of interest.

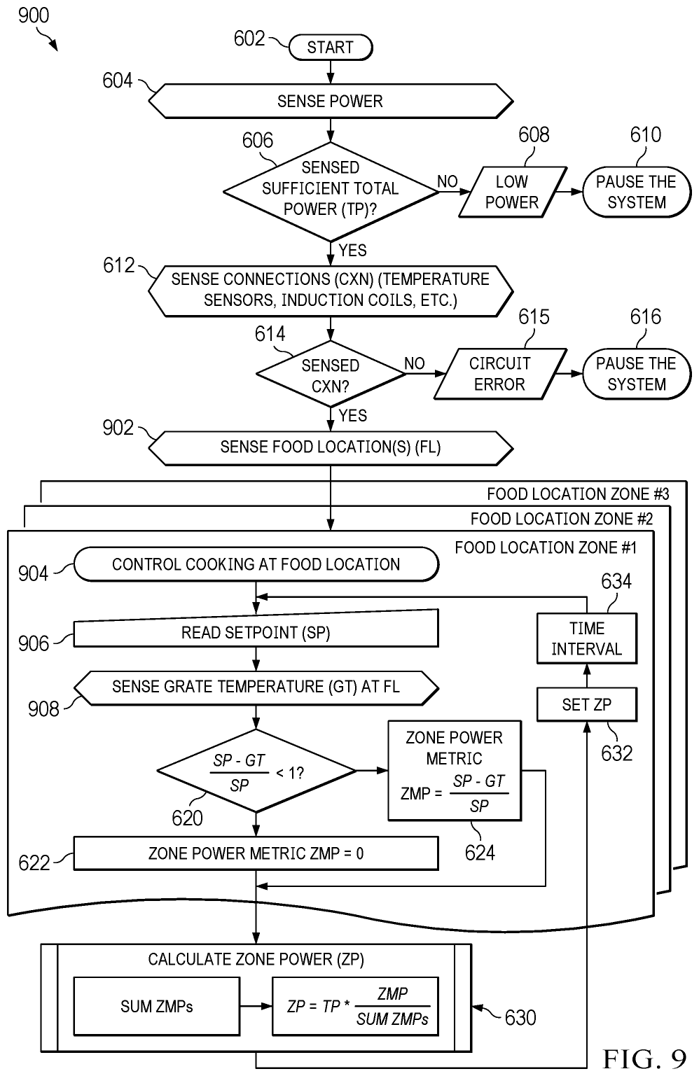

Referring now to FIG. 9, a flow chart of a control method 900 for dynamic zonal control based on food location sensing and grate temperature sensing at the location of food according to aspects of the present disclosure is shown. The method 900 starts at step 602, with power being sensed at step 604. If total power available to the device is not sufficient, as determined at step 606, low power may be indicated at step 608 and the system paused at step 610. On the other hand, if sufficient power is determined to be available at step 606, connection to appropriate sensors, coils, and other hardware may be tested at step 612.

As shown at logical step 614, without appropriate connections, a circuit error may be indicated at step 615 and the system paused at step 616. If connections are present as needed at step 614, food locations may be sensed at step 902. Control and operation for the plurality of zones may then begin. Three separate food location zones are shown in FIG. 9, but it should be understood that more or fewer may be present. Additionally, each zone does not necessarily has the exact same control methodology

As shown at step 904, zonal control may start for each relevant zone. At step 906 a setpoint is read (from, e.g., a user control). At step 908 a grate or cooking surface temperature at the instant zone may be read. At step 620 it may be determined whether the quantity of the set point minus the grate temperate, divided by the setpoint, is less than 1. If so, a zone power metric for the zone in question is set to zero at step 622. If the quantity of the set point minus the grate temperate, divided by the setpoint, is not less than 1, the instant zone power metric is set to the quantity of the setpoint minus the grate temperature, divided by the setpoint.

With steps 902-908 and 620-624 complete, zone power is calculated at step 630. This includes summing the zone metric power results and then setting the zone power to the total power available multiplied by the ratio of the zone power divided by their sums, for use in setting the zone power at step 632 (for each zone). As the power may be adjusted continually, or on a periodic basis, a time interval may pass as shown at step 634, whereupon steps 618 through 624 are repeated for each zone, along with step 630, and then steps 632 through 634 again for each zone. As before, the control method may be interrupted by powering down or another user selected operation.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)— (a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An outdoor cooking grill comprising:
a cooking surface;
at least one induction coil below the cooking surface; and
a power supply providing current to the at least one induction coil heating the cooking surface.

2. The grill of claim 1, wherein the at least one induction coil comprises a plurality of induction coils arranged below the cooking surface.

3. The grill of claim 2, wherein the plurality of induction coils correspond to a plurality of separately controllable cooking zones on the cooking surface.

4. The grill of claim 3, further comprising a capacitive food sensor detecting a location of food on the cooking grate.

5. The grill of claim 1, wherein the power supply comprises a direct current power source.

6. The grill of claim 1, wherein the power supply comprises an alternating current power source.

7. The grill of claim 1, further comprising a shielding layer interposing the cooking surface and the at least one induction coil.

8. The grill of claim 1, further comprising a fan delivering air from at least one of the cooking surface, the at least one induction coil, and the shielding layer to an interior of a cooking chamber containing the cooking surface.

9. The grill of claim 1, further comprising a microcontroller controlling operation of the at least one induction coil.

10. The grill of claim 1, wherein at least a portion of the cooking surface is removable for placement of an induction compatible cooking implement.

11. The grill of claim 1, further comprising a controller determining a cooking surface temperature by pulse induction using the at least one induction coil.

12. The grill of claim 1, further comprising a controller determining a food location on the cooking surface by pulse induction using the at least one induction coil.

13. The grill of claim 12, wherein the controller activates one of a plurality of induction coils to heat the cooking surface at the food location.

14. An outdoor cooking grill comprising:
an electrically powered induction coil;
a cooking surface in the interior of an outdoor cooking chamber;
a ferrous material proximate the cooking surface that generates heat in response to induced magnetic fields from the induction coil.

15. The outdoor cooking grill of claim 14, wherein the ferrous material is contained in the cooking surface.

16. The outdoor cooking grill of claim 14, wherein an infrared emitter comprises the ferrous material.

17. The outdoor cooking grill of claim 14, further comprising an air plenum containing a fan moving air into the outdoor cooking chamber from the electrically powered induction coil.

18. An outdoor cooking grill comprising:
a cooking chamber;
a ferrous cooking grate at the bottom of the cooking chamber;
a firebox containing a plurality of induction coils; and
a controller operative to energize the plurality of induction coils in response to user activation, the induction coils causing a heating of the ferrous cooking grate.

19. The outdoor cooking grill of claim 18, further comprising a shielding layer interposing the ferrous cooking grate and the plurality of induction coils.

20. The outdoor cooking grill of claim 18, further comprising a capacitive sensor used by the controller to determine a location of a food item on the cooking grate, the controller activating a subset of the plurality of induction coils to heat the ferrous cooking grate below the food item.
